(19) United States
(12) Patent Application Publication
(10) Pub. No.: US 2009/0059321 A1
(43) Pub. Date: Mar. 5, 2009

(54) System and Method for Generating Color-Correct Scanned Image Files in a Network Environment

(75) Inventor: Robert R. Buckley, Rochester, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: XEROX CORPORATION

(21) Appl. No.: 11/849,024

(22) Filed: Aug. 31, 2007

(51) Int. Cl. H04N 1/60

(52) U.S. Cl. 358/504

(57) ABSTRACT

Present systems and methods provide for the creation of scanned image files accurately which accurate represent the colors of scanned color image prints. A scanner can be calibrated using a calibration server which receives a scanned calibration target image file and compares color values data therein with known reference values to produce a Correction. The server subsequently applies to the correction to other scanned image files it receives from the scanner to generated color correct scanned image files.

### BACKGROUND AND SUMMARY

Digital scanners typically scan a hardcopy print to digitally capture images from the print in the form digital image signals which can be saved as one or more scanned image files. The image file can then be printed to reproduce the print images, or portions thereof, or processed in some way using known image processing software for a variety of uses.

Color scanners capture color print images in scanned image files having RGB data corresponding to the color values of the print images that have been scanned. Scanners can experience color drift in that the RGB values measured by scanners can vary due to aging of the lamp and/or imaging sensor and differences in lamp intensity among different scanners, even of the same scanner model. Scanners are thus periodically calibrated to improve the accuracy of the RGB data generated by the scanner during a scan.

One way to calibrate a scanner is to scan an image and then adjust the scanner controls or scanner software until the image looks acceptable on a display or print. Another way is to scan a target, such as an IT8 scanner target, and then have scanner calibration software on a PC compare the scan of the target with the reference values in a file and create an ICC profile for the scanner. In both these cases, the scanner is connected to a scan station and the calibration is a separate operational step and a break in the scanning workflow.

Aspects of the present systems and methods include a system that includes a scanner configured to generate scanned image files providing a digital representation of scanned print images including a calibration target image file providing a digital representation of a scanner calibration target print, and a calibration server remotely located from said scanner and electronically connected thereto via a network connection, said calibration server configured to compare said calibration target image file with known reference values and generate a Correction accessible to the calibration server, rather than the scanner, for color-correcting scanned print images at the server obtained from the scanner.

In one aspect, a method includes generating a calibration target image file providing a digital representation of a scanned scanner calibration target print, transmitting said calibration target image file to a calibration server via a network connection, using said calibration target image file to generate a scanner color Correction, and using said scanner color Correction to color-correct scanned image files providing a digital representation of scanned print images obtained from the scanner.

### BRIEF DESCRIPTION OF THE DRAWINGS

FIG. 1 is provides an example of a network in which present systems and methods may be used;

FIG. 2 is a flow diagram illustrating a process for calibrating a scanner;

FIG. 3 is an illustration showing a scanner calibration target print for use with the present system and methods; and

FIG. 4 is a flow diagram illustrating a workflow used in the present systems and methods for color-correcting a scanned image file at a network server.

### DETAILED DESCRIPTION

For a general understanding of the present systems and methods, reference is made to the drawings. In the drawings, like reference numerals have been used throughout to designate identical elements. In describing the present systems and methods, the following term(s) have been used in the description:

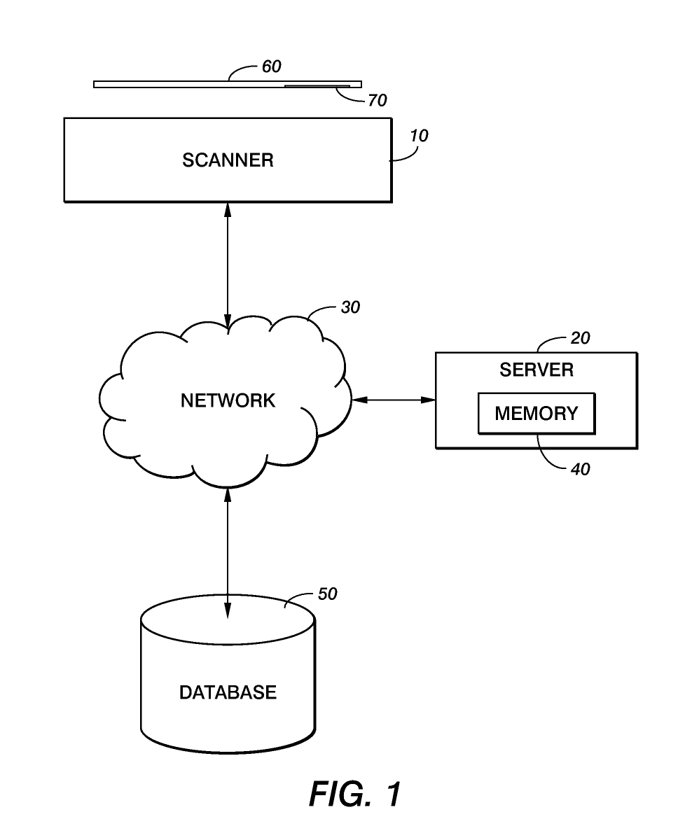

Referring to FIG. 1, present systems and methods may be used to generate a Correction, or color-Correction, for a scanner 10 linked to a calibration server 20 via a communications network 30, such as for example a Local Area Network (LAN). The scanner 10 can be part of an image forming device, such as a Xerographic copier/printer, or other Multifunction Device (MFD) having a scanner. The scanner 20 can be a basic, inexpensive scanner for creating scanned image files. The calibration server 20 includes memory 40 and can receive common files and other resources from the scanner 10 via network 30, as shall be described in further detail below.

The scanner 10 scans hardcopy color print(s) 60, also known as original document(s), to digitally capture color images from the print(s) in the form of digital image signals which can be saved as one or more scanned image files. The image files can also be printed to reproduce the hardcopy color print images, or portions thereof, using a color printer connected to the calibration server via the network 30, or digitally processed and saved for use in other manners.

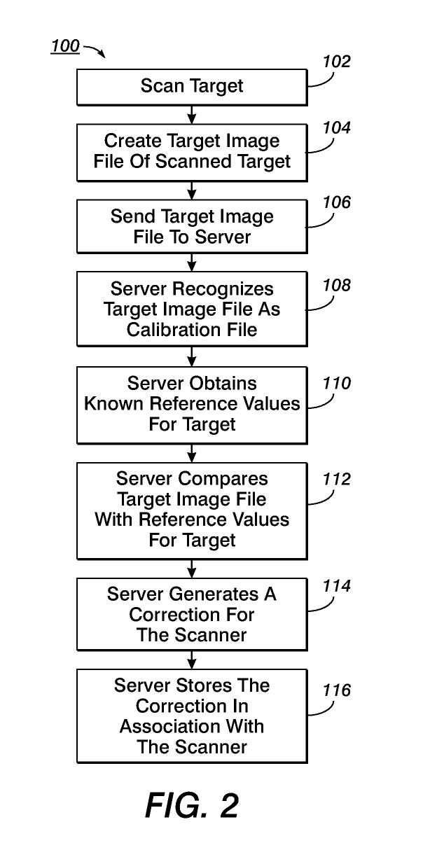

With reference to FIG. 2, in a scanner calibration process 100, a user scans a calibration target 300 in the form of a hardcopy print, at 102. The scanner calibration target 300 can be a suitable hardcopy print with a color calibration image having known reference values which are made available for comparison to corresponding RGB values obtained by the scanner when scanning the target, as described in further detail below. The reference values are known to accurately represent the RGB data obtained from a scan of the color calibration target using an accurate, calibrated scanner. The reference values can be provided by the manufacturer of the calibration target, or can be obtained using accurate, and properly calibrated, sensing devices in a known manner. The reference values can be saved in the server memory 40, in a database 50 or in other manners which are accessible by the server.

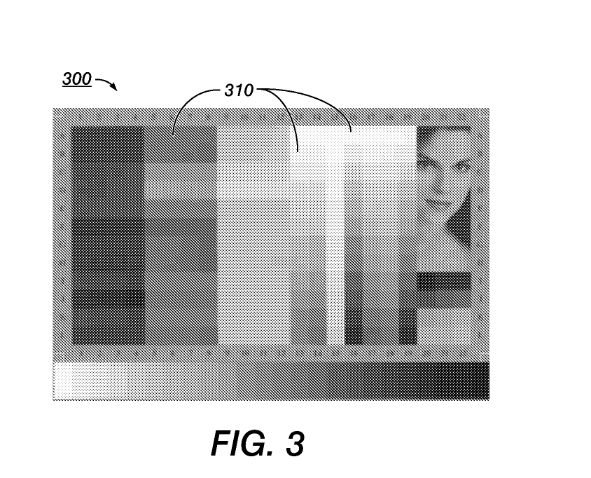

Referring now to FIG. 3, an example of a calibration target, which should not be considered limiting, is shown generally at 300. The example target 300 is an IT8.7/2 reflective target commonly used for calibrating image forming devices such as scanners. The calibration target 300 includes one or more image portions, such as color patches 310, having the known reference values. Present systems and methods can used tailored calibration targets created for specific substrates, such as a particular paper, etc., and/or specific colorants. Such tailored targets can be formed of substrates and/or colorants similar to those used in materials that are to be subsequently scanned to calibrate the scanner for those specific constraints thereby further reducing color errors and the like. Present systems and methods can use calibration targets of multiple pages having calibration target color patches spread over multiple pages if so desired.

In further reference to FIG. 2, the scanner creates a calibration target image file at 104 of the calibration target scanned at 102. The target image file can be created, for example, by doing a scan-to-file, a scan-to-export or a scan-to-fax procedure when scanning the target at 102. Known software, such as SmartSend™ from Xerox for example, can simplify document capture, conversion and routing for the creation of scanned target image files. The calibration target image file includes color values data, which may be RGB data, defining the color properties of the calibration target image, such as the color patches 310, generated during the scan. The color values data may be uncalibrated color values data, or calibrated color values data calibrated by the scanner if the scanner is so capable. The calibration target image file may include an ICC profile defining or augmenting the color values data.

The calibration target image file is sent to the calibration server 20 connected to the scanner via the network connection at 106. Present systems and methods can include creating and sending the calibration target image file to the server 20 in a single programmed workflow routine, such as by using the scan-to-export routine, or the creating and sending can be accomplished separately. The calibration server 20 receives the target image file at block 108 and recognizes it as the calibration target image file for the calibration target scanned by the scanner 10. A calibration target image identifier can be used by the calibration server to associate the target image file with the specific calibration target scanned at 102.

The calibration target image identifier can be generated using a scan template, or other configured set of instructions provided to the scanner. The calibration target image identifier can be included in the image file, such as by using metadata, or it can accompany the image file as it is sent to the server 20 in the form of another, associated file. The calibration target image identifier can also be a mark (shown as 70 in FIG. 1) on the calibration target print 60, such as a glyph, bar code, or identifying text, which is scanned together with the calibration target and recognized as the calibration target image identifier either at the scanner 10 at the calibration server using known image processing techniques. The mark 70 can preferably be located in a regular location on the calibration target to prevent the need for analyzing the entire page in searching for it.

The calibration server 20 also associates the target image calibration file with the scanner using the calibration target image identifier, or by determining which scanner has sent it the target image calibration file. Having recognized/identified the target image file as a calibration file of a specific calibration target generated by a specific scanner, the server analyzes the calibration file and extracts the color values, such as for example RGB values, for the target therefrom.

The calibration server 20 obtains the known reference values for the color values data of the target 300 at 110. The known values can be retrieved from the calibration server memory 40, or from a database 50 via the network 30, where they have been stored in association with the calibration target as described above.

The server 20 then compares the scanner-specific color values from the target image file with the known reference values for the target at 112, and generates a Correction, also referred to as a Color-Correction or Calibration-Correction, for the scanner at 114. The Correction can be a transform such as for example a look up table, etc. that converts the values in the scanner-specific color space to values in the reference space, such as for example CIELAB color space or some other known and calibrated color space. This can be accomplished because the server recognizes the target and therefore knows the reference values of the target patches 310.

The Correction transform is applied to image files generated by the scanner in subsequent scans to create color-corrected image files as described at 130 below. For scanners exporting color data image files having an ICC profile, or other data corresponding to a calibrated color space, the Correction generated at 114 can be a corrected ICC profile.

The server 20 stores the Correction at 116 associated with the scanner 10 in a manner accessible by the server, such as in server memory 40.

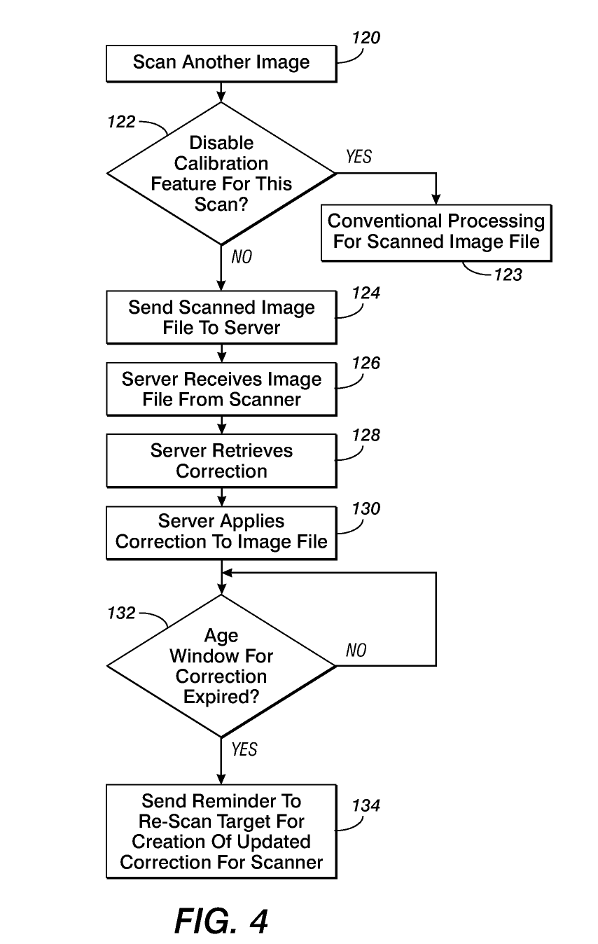

The server 20 uses the calibrated Correction to generate color-corrected scanned image files from images files generated by the scanner. Referring now to FIG. 4, the scanner 10 is used to scan another print image thereby generating a scanned image file at 120. It is contemplated that the calibration feature described herein can be disabled by a user of the scanner 20 using instructions provided by a User Interface at 122. If disabled, conventional processing of the scanned image file can occur at 123.

If the feature is enabled, the scanned image file is sent to the server at 124 via the network 30. The server 20 receives the image file from the scanner at 126 and associates it with the scanner, such as, for example, by using metadata. The server 20 retrieves the Correction at 128 and applies it to the image file at 130 to adjust or correct the color values to produce a color-corrected scanned image file similar to one that would be generated by the scanner just after it had been calibrated. The server 20 can convert uncalibrated color values data to calibrated color values data by using the Correction transform. The server 20 can update or replace the ICC profile with one based on its analysis of the target image file at 112 above. The ICC profile can be applied by the server 20 at 130 correcting the ICC profile, or replacing it, or inserting an ICC profile if one is not in the file received from the scanner, to generate color corrected image files from subsequent scanned image files thereby tagging the scanner-specific data in the image files so that the scanner-specific values can be converted to standard color values using a color management system.

An age window for the Correction can be provided and if the server 20 determines, at 132, that the age window has expired, the server can send a reminder to the User at 134 to re-scan the calibration target to create an updated Correction in a manner as described above.

In this manner, the present systems and methods integrates the scanning of a calibration target into a scan-to-file, or scan-to-export workflow on a scanner, which can be a Multifunction Device. The exported scanned image file with the scan of the calibration target is sent to a server, recognized as a calibration target image file, wherein the server uses known reference values for the target values to adjust the color values of subsequent scanned image files sent to the server from the scanner.

Present systems and methods make the calibration of a scanner more transparent, simple and easy as possible, especially in the case of a scan-to-file workflow, where the scanner may be connected directly to a network, as is the case with an Multi Function Device, rather than to a local PC or scan station. If a user is concerned with the color accuracy of the scan, the user can initiate the procedure described here, with most of the work being done off the scanner by a server on the network. The present systems and methods are particularly useful for network scanners that are not connected to a PC or scan station and do not have elaborate on-box calibration software.

After the scanner 10 has been calibrated all scanned image files subsequently processed by the server are adjusted using the Correction to provide color-correct scanned image files.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system comprising:
a scanner configured to generate scanned image files providing a digital representation of scanned print images including a calibration target image file providing a digital representation of a scanner calibration target print; and
a calibration server remotely located from said scanner and electronically connected thereto via a network connection, the calibration server is configured to compare the calibration target image file with known reference values and generate a Correction accessible to the calibration server for color-correcting scanned print images at the server obtained from the scanner.

2. A system as claimed in claim 1 wherein the calibration server receives a calibration target identifier identifying the calibration target as corresponding to the scanner calibration target print.

3. A system as claimed in claim 1 wherein the calibration target image file includes a calibration target identifier identifying the calibration target as corresponding to the scanner calibration target print.

4. A system as claimed in claim 1 wherein the server receives the calibration target image file from the scanner in an export-to-file routine.

5. A system as claimed in claim 1 wherein the server receives the calibration target image file from the scanner in an scan-to-file routine.

6. A system as claimed in claim 1 wherein the server receives the calibration target image file from the scanner in an scan-to-fax routine.

7. A system as claimed in claim 1 wherein the server is configured to compare color values data from the calibration target image file with known reference values to generate the Correction.

8. A system as claimed in claim 1 wherein the Correction is a color correction transform.

9. A system as claimed in claim 9 wherein the color correction transform includes a look up table.

10. A system as claimed in claim 1 wherein the Correction is a corrected ICC profile.

11. A method comprising:
generating a calibration target image file providing a digital representation of a scanned scanner calibration target print;
transmitting said calibration target image file to a calibration server via a network connection;
using said calibration target image file to generate a scanner color Correction; and
using said scanner color Correction to color-correct scanned image files at the calibration server received from the scanner.

12. The method as claimed in claim 11 further comprising:
retrieving known reference values for the calibration target image file; and
comparing the known reference values to color values data from the calibration target image file to generate the scanner color Correction.

13. The method as claim in claim 11 wherein the calibration server receives a calibration target identifier identifying the calibration target as corresponding to the scanner calibration target print.

14. The method as claim in claim 11 wherein the calibration image file includes a calibration target identifier identifying the calibration target as corresponding to the scanner calibration target print.

15. The method as claim in claim 11 wherein the server compares color values data from the calibration target image file with known reference values to generate the Correction.

16. The method as claim in claim 15 wherein the Correction is a color correction transform.

17. The method as claim in claim 16 wherein the color correction transform includes a look up table.

18. The method as claim in claim 11 wherein the Correction is a corrected ICC profile.
